(19) United States
(12) Patent Application Publication
(10) Pub. No.: US 2020/0279558 A1
(43) Pub. Date: Sep. 3, 2020

(54) ATTENTION PROCESSING FOR NATURAL VOICE WAKE UP

(71) Applicant: DSP Concepts, Inc., Santa Clara, CA (US)

(72) Inventors: Ke Li, San Jose, CA (US); Paul Beckmann, Santa Clara, CA (US)

(21) Appl. No.: 16/290,629

(22) Filed: Mar. 1, 2019

(51) Int. Cl. G10L 15/22

(52) U.S. Cl. CPC G10L 15/22; G10L 2015/088

(57) ABSTRACT

A method and apparatus for dynamically adjusting the sensitivity of a wake word recognition system based on room conditions.

### BACKGROUND

### Field

This technology as disclosed herein relates generally to hands free voice interface systems and, more particularly, to wake word functionality.

### Background

The voice trigger algorithm is an integral part of hands free voice interface systems and products. A specific keyword, like “Alexa”® or “Hey Google”®, marks and initiates the start of the user's interaction with the product and activates, “wake-up”, the product for further interactions with the user. The trigger word algorithms are available from many suppliers (e.g., Sensory®, Amazon®, Google®, Cyberon®, Nuance®, Sound Hound®, etc.). The performance of the wake word algorithm is usually measured based on two metrics: the first metric being Probability of false rejection (P_FR)—What is the probability of saying the wake word and the algorithm does not detect it. This is also sometimes call the “Probability of miss”. Ideally, P_FR should be as close to 0 as possible; and the second metric being Number of false alarms—How often does the algorithm inadvertently wake up when the trigger word was not uttered. This may be reported as number of false alarms per hour, or number of false alarms per 24 hour period. Ideally, the user-developer will want this equal to zero because it is very annoying for the product to wake up when it wasn't supposed to.

Many of the commercially available trigger algorithms have a tunable sensitivity parameter. This allows the user-developer to make tradeoffs between the P_FR and number of false alarms. For example, the user-developer could make the algorithm very insensitive leading to fewer false alarms (this is better), but the tradeoff is that this leads to a higher P_FR value (this is worse).

A common practice is to vary the sensitivity and measure the resulting P_FR and number of false alarms. This leads to a plot similar to the one shown in FIG. 1. This is often referred to in industry as a “Receiver Operating Characteristic” or ROC. The x-axis indicates the P_FR and the y-axis the number of false alarms. The exact units aren't important for this illustration, but there are at least a few things to note when viewing the plot; 1.) The ideal location for product performance is the bottom left hand corner. The point where you have fewer or zero false alarms and fewer or zero false rejections. However, the wake word algorithm is not able to achieve this; and 2.) The sensitivity tuning allows you to tradeoff false alarms and false rejections, but you are confined to operating on the curve. It is typical for the product developer to use the graph during development and the product is typically released with a fixed sensitivity tuning.

In practice, however, the problem is that it is often impossible to find a compromise in the sensitivity setting that achieves the desired result. A solution to this problem is needed. Instead of providing a sensitivity adjustment, some trigger words output a score. The score reflects the confidence that the algorithm has that the trigger word was set. The product developer sets a threshold and if the score is above the threshold, this counts as a trigger. By varying the threshold, the product developer is able to tune the sensitivity of the algorithm. However, as indicated it is often impossible to find a compromise in the sensitivity setting. A better system and/or method is needed for improving the performance of wake word algorithms.

### SUMMARY

The technology as disclosed herein includes a method and apparatus for dynamically adjusting the sensitivity of a wake word recognition system based on room conditions. A common practice in industry is to tune the trigger word algorithm to make the best tradeoff between false alarm and false rejection. The ideal set point depends upon the specific application and tuning the sensitivity is usually left to the final product developer. In many cases, the product developer is unhappy with the tradeoffs. They would like a more sensitive product, but in order to reduce false alarms, they make the algorithm less sensitive. In practice, however, the problem is that it is often impossible to find a compromise in the sensitivity setting. A common practice in the industry is to tune the sensitivity during development and release the product with a fixed sensitivity. This invention as disclosed and claimed herein solves this problem by dynamically adjusting the sensitivity based the level of interaction with the device and on room conditions. A representative sensitivity tuning curve is illustrated in FIG. 1, where the more sensitive the tuning the greater the number of false alarms and where the less sensitive the tuning the greater the probability of a false rejection.

The technology as disclosed and claimed leverages the fact that some false alarms and false rejections are more than others to users of the product depending on the room conditions and the way the user is presently interacting with the product. For example when a user is not actively interacting with the product and it false triggers this is perceived as bad. It is a very obvious failure of the product. Plus, it raises privacy concerns and questions. “Is someone listening to my conversations?” Further, when a user is actively engaged with the product and there is a false rejection (it doesn't respond), then it is very annoying as the product appears not to work properly. Similarly, some false alarms and false rejections may not be perceived as particularly annoying to the end user of the product. For example when a user is actively interacting with the product and it false triggers this is perceived as not so bad. (no privacy concerns). Further, if a user tries to wake up the product “out of the blue” (the user hasn't been interacting with it recently), the user may blame themselves, because maybe they didn't say the trigger just right our perhaps some noise got in the way. One implementation of the technology as disclosed and claimed allows false alarms to be reduced while maintaining low false rejection probabilities while actively interacting with the product. The technology provides the best of both worlds by assessing room conditions and user interactions and adjusting sensitivity dynamically. The invention is general and can be applied to any trigger word with a sensitivity adjustment.

The core concept of the technology is to vary the sensitivity dynamically in the product based on characteristics of the environment that the product is in, and/or based on the level of engagement between the product and the user. The sensitivity setting could be changed one time during setup or constantly at run-time. For one implementation of the technology as disclosed and claimed, the technology automatically varies sensitivity based on one or more of these parameters:
1. Room impulse response/reverb time. This indicates the size of the room.
2. Background noise level
3. Type of noise (music, speech, motor, stationary)
4. Residual output of the echo canceler (this indicates the noise level in the room by ignoring the music playback)
5. Direction of the noise
6. Direction of speech
7. Time since the last wake word detection
8. Voice activity detector output
9. Level of noise in the room
10. Level of the speech utterance
11. Number of independent sound sources in the room
12. Number of trigger words currently being detected
13. Location of product in room (against wall, in corner, in middle, etc.)
14. Initial trigger word vs. follow up utterance

For one implementation of the technology, the approach that is used is to have two sensitivity levels: more sensitive and less sensitive. By way of illustration, for one implementation using one of the above parameters, if the wake word was not detected for about approximately 3 or more minutes, then we switch to the low sensitivity mode. This helps to reduce false alarms. The time for inactivity could be measured from the last interaction with the product instead of the last wake word detection. Touching the product and/or moving the product, for example, or changing the volume setting or other setting would also count as an interaction. When a wake word is detected, for one implementation, the technology switches to high sensitivity mode. This helps to eliminate false rejections when actively engaged in a conversation with the device. In some sense, this matches how humans work. If you are absorbed in something, it will be more difficult for someone to get your attention. You might just not hear them call your name. However, once they have your attention, you'll be listening more attentively. After several minutes without any interaction, you switch to the less sensitive mode.

For one implementation of the technology as disclosed and claimed herein an attention processing system for dynamically adjusting natural Voice wakeup sensitivity includes a wake-word detection system having a detection sensitivity threshold whereby if the detection sensitivity threshold is exceeded a wake-word detection trigger is activated, where the detection sensitivity threshold is the sum of a predefined threshold baseline and a dynamically adjustable threshold that is dynamically adjusted based on parameters illustrative of the environment where the wake word detection system is located. For one implementation of the attention processing system the parameters are illustrative of the environment are one or more of the physical characteristics of the room, the characteristics of the sound sources and audible sound, and the characteristics of the user's interaction with the wake word detection system. For yet another implementation of the technology as disclosed and claimed, the attention processing system the parameters are illustrative of the environment where two or more parameters include parameters relating to one or more of the physical characteristics of the room, the characteristics of the sound sources and audible sound, and the characteristics of the user's interaction with the wake word detection system. For one implementation of the technology, the two or more parameters include one or more of Time Since The Last Wake-word Was Detected and Level Of Noise in the environment. For one implementation of the technology the two or more parameters are logically AND'd to determine the dynamically adjusted threshold.

For one implementation of the technology as disclosed and claimed herein an attention processing method for dynamically adjusting natural Voice Wakeup Sensitivity includes providing a wake-word detection system that is activating a wake-word detection trigger when a detection sensitivity threshold is exceeded, where the detection sensitivity threshold is the sum of a predefined threshold baseline and a dynamically adjustable threshold that is dynamically adjusted based on parameters illustrative of the environment where the wake word detection system is located; and triggering the wake word detection trigger, when the detection sensitivity threshold is exceeded.

There is clear utility for the present technology as disclosed and claimed because there are many commercial products that use wake words, but not one as disclosed and claimed herein. The features, functions, and advantages that have been discussed can be achieved independently in various implementations or may be combined in yet other implementations further details of which can be seen with reference to the following description and drawings.

These and other advantageous features of the present technology as disclosed will be in part apparent and in part pointed out herein below.

### BRIEF DESCRIPTION OF THE DRAWINGS

For a better understanding of the present technology as disclosed, reference may be made to the accompanying drawings in which:

FIG. 1 is an illustration of a false alarm and false rejection curve;

FIG. 2 is an illustration of a system for adjusting wake word sensitivity;

While the technology as disclosed is susceptible to various modifications and alternative forms, specific implementations thereof are shown by way of example in the drawings and will herein be described in detail. It should be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DESCRIPTION

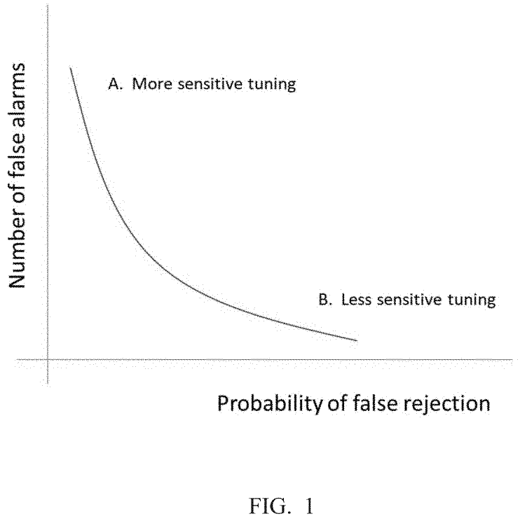

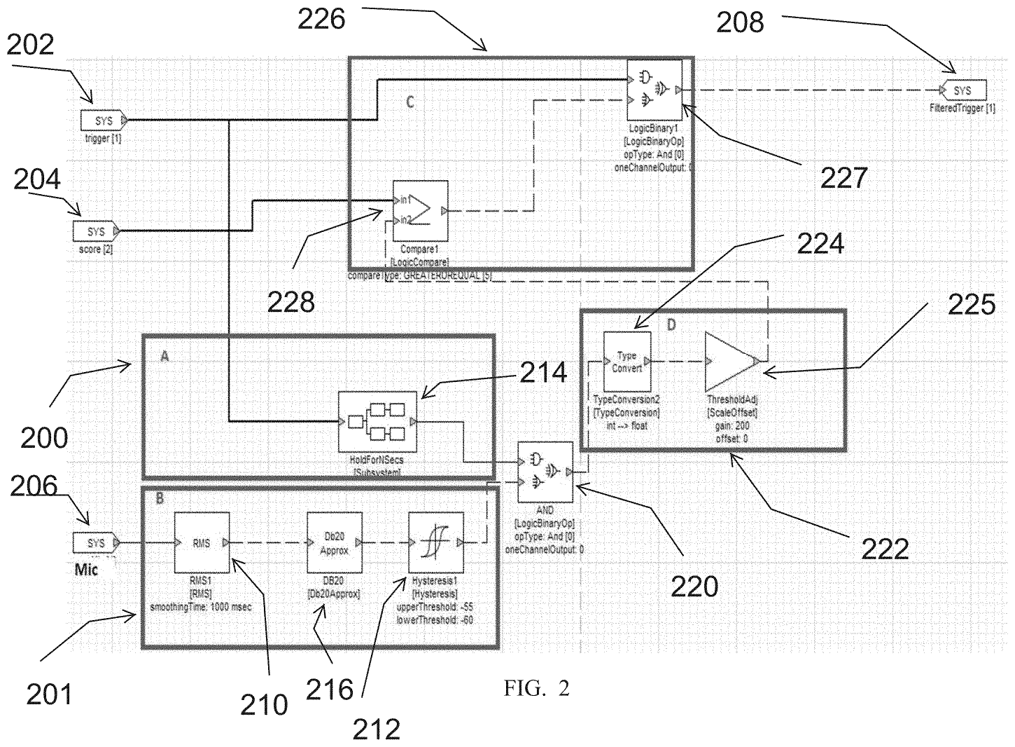

According to the implementation(s) of the present technology as disclosed, various views are illustrated in FIGS. 1-2 and like reference numerals are being used consistently throughout to refer to like and corresponding parts of the technology for all of the various views and figures of the drawing. Also, please note that the first digit(s) of the reference number for a given item or part of the technology should correspond to the Fig. number in which the item or part is first identified. Reference in the specification to “one embodiment” or “an embodiment”; “one implementation” or “an implementation” means that a particular feature, structure, or characteristic described in connection with the embodiment or implementation is included in at least one embodiment or implementation of the invention. The appearances of the phrase “in one embodiment” or “in one implementation” in various places in the specification are not necessarily all referring to the same embodiment or the same implementation, nor are separate or alternative embodiments or implementations mutually exclusive of other embodiments or implementations.

One implementation of the present technology as disclosed comprising dynamically adjusting the sensitivity of a wake word recognition system teaches a novel system and method for attention processing for natural voice wakeup. The technology as disclosed and claimed is a system that is constantly sensing the acoustic signature of the room for a person to say the trigger word. The goal is to detect the trigger word (True Positives) but not trigger when then trigger word has not been spoken (False Positives). Since no trigger word engine is perfect, there are always tradeoffs between true positives and false positives.

Audio signals are typically processed in frames. For speech applications, acoustic data might be sampled at about approximately 16 kHz and a typical frame might be about approximately 256 samples (0.016 seconds of speech). The wake word detector typically calculates a score every frame (this is true even though the wake word is spread over multiple frames), If the score is above a certain threshold, T, then a wake word is considered detected. If T is set to a large value, then the wake word engine is less likely to trigger making it less sensitive. In turn, this means a lower rate of false positives but also a lower rate of true positives. Similarly, if T is set to a small value, then the wake word engine is more likely to trigger making it more sensitive. In turn, this means a higher rate of false positives but also a higher rate of true positives. The technology as disclosed and claimed involves dynamically changing the wake work sensitivity threshold based upon the acoustical and user context of the room.

For one implementation of the technology as disclosed and claimed, the system has two values that sum together to set the value of T:

T=Tb+Tadj

Where Tb stands for a baseline threshold and Tadj is an adjustable parameter.
Tb is normally a static value that is established during the product's design for typical use cases. However for another implementation, Tb might be a quasi-static value that varies slowly over the operation of the product where the value varies based on a learning function. Here, slowly might be on the order to hours, days, or weeks.

Tadj is a dynamic value that depends upon estimated parameters of the room as described above. Tadj can be either a positive (making the system more sensitive) or negative number (making the system less sensitive). Some of the features for calculating Tadj are specific to the specific wake word engine being used. It is also possible that the system might employ multiple Tadj parameters and resulting thresholds T if multiple wake word engines are used

An exemplary system is illustrated in FIG. 2. The inputs to this algorithm are:
1. Trigger: This is a Boolean value. 0=no wake word detected, 1=wake word is detected. 202
2. Score: This is a floating point value that indicates the confidence of the wake word engine with regards to its wake word detection 204.
3. Mic: This is the same signal that is fed to the wake word detector and normally is connected to some form of processed microphone input 206.
This exemplary system is not intended to be limiting in any way, but is representative of how the various characteristics of the environment can be logically used individually or in combination to dynamically adjust the wake word detection sensitivity. The various characteristics of the environment can be utilized independently or logically OR'd or logically AND'd in combination.

For one implementation of the technology, in normal operation, the Trigger value is nominally zero and the Score is near zero when no wake word is detected. If the wake word engine believes it has seen a wake word, then Trigger is set to 1 and the Score is some value larger than zero. For exemplary purposes, we assume the wake word engine outputs scores between 0 and approximately 20,000 with a score a score of 200 or larger representing a high level of confidence.

The output of this algorithm is:
Filtered Trigger 208: This is a Boolean value. 0=we declare that no wake word was detected, we declare that a wake word was detected.
   In one implementation of the system as shown, Tadj depends upon two key features:
1. Time since last trigger: If there has not been a trigger in the past X seconds, then the Tadj component from this feature will be a positive value, making the wake word harder to trigger. If there has been a trigger in the past X seconds, then the Tadj component from this feature will be 0, making the wake word easier to trigger. A typical value of X might be 300 seconds.
   The purpose of this feature is to recognize that users are more likely to trigger the device multiple times in a short period of time as they try to accomplish some task. At that point, the user moves on to another task.
   (Note: As discussed previously, the parameter—Time Since Last Interaction—could be utilized as a different implementation, but with a similar objective)
2. Background noise level of the signal feeding into the wake word engine: If this background noise level is small, (as an example, less than approximately 55 dB SPL) then this feature sets its component of Tadj to 0. If the SPL level is higher than some threshold, then this feature will contribute to Tadj being larger than zero. For one implementation, background noise level is computed by applying time smoothing to RMS signal level 210 of each frame. In this particular implementation as shown in FIG. 2, 1000 ms time smoothing is applied to RMS value of each frame.
   The purpose of this feature is to recognize that quiet environments are less likely to have false triggers. In turn, this means we want Tadj to be small (i.e., near zero) so that the trigger is more sensitive.
   Note that the implementation of the system as shown includes a hysteresis block 212 on the output of the RMS SPL calculation. The hysteresis block ensures that once the room is considered to have loud ambient sound (i.e., above −55 dB SPL) then it must become quite quiet in the room (below −60 dB SP) before the feature resets and becomes more sensitive The output of the hysteresis block is either 0 or 1. The specific values used to trigger the hysteresis block will depend upon the typical use case for the device.

Box A 200 of the implementation of the system as shown implements the first feature described above. The wake word detector's Boolean output is fed into a block that inverts the Boolean value and then holds the inverted trigger state for X seconds 214. Hence, if the wake word engine is triggered, the output of this block goes to zero for X seconds making the system more sensitive to future triggers.

Box B 201 of the exemplary system implements the second feature described above. The microphone signal is fed into an RMS computation block 210 with a long time constant (1 second being a representative value) The signal is then converted into dB level 216 and fed into a hysteresis block 212 with threshold set to −55 dB and −60 dB. The output of the hysteresis block is either 0 or 1.

The outputs of Box A and Box B are logically AND'ed together 220. Hence, if both features are 1 then the output of the AND gate is 1 and Tadj will be large. If either feature's output is zero then Tadj will be small. This means that the system only becomes less sensitive (output of a 1) if the user has not triggered the wake word engine for some long period of time AND the room is fairly loud.

Box D 222 of the implementation of the system as shown then converts the boolean output 224 to a floating point output of either 0 (the system will be very sensitive) or 200 (the system will be less sensitive). The threshold adjustment is performed 225.

Finally, Box C 226 of the implementation of the system as shown compares 228 the Score input 204 to the output of Box D 222. If the Score is larger than Box D output (0-200) and the wake word Trigger is set to 1, then the Filtered Trigger 208 signal is set to 1. For one implementation of the system as shown, the result of the comparison 228 is And'd 227 with the trigger 202 to determine the filtered trigger 208, For Tb (baseline) has been set to zero in this example. But, Box D could include a summation block to add in Tb.

Other potential features for Tadj are:
1. Acoustic content classifier: For one implementation, if there is a classifier that determines the existence of music in the room, then Tadj can be changed based on that. Another implementation would be if there is a Voice Activity Detector that determines if there is speech present in the room.
2. Frequency of close triggers: If in the past N seconds there has been a consistent amount of triggers where the score is close to but not quiet at T, then Tadj can be adjusted to successively smaller values until a certain floor value. The intent here is that it's not likely for a false positive to happen consecutively in a short span of time while it's highly likely for false negatives to occur in a short time period.

As mentioned above, it might also be appropriate to slowly vary the value of Tb (the baseline). For example, the RMS SPL in the room might be averaged over an hour long period and if it fails below some value then Tb might be reduced making the overall system more sensitive. The broad concept is that the technology as disclosed uses a time varying trigger. The trigger is the sum of two parameters: one that is quasi-static (or static) and one that varies more rapidly, depending upon the acoustic environment and/or the previous user behavior. There are several ways to estimate the acoustic environment. Additionally, there are several ways to estimate user behavior. In addition, Tadj can be continuous value. In the implementation illustrated in FIG. 2, Tadj is switched between 0 and 200. For example, instead of using two discrete numbers, Tadj can be progressively increased from smaller number to larger number while holding trigger state for X seconds.

The various implementations and examples shown above illustrate a method and system for attention processing for natural voice wakeup. A user of the present method and system may choose any of the above implementations, or an equivalent thereof, depending upon the desired application. In this regard, it is recognized that various forms of the subject attention processing method and system could be utilized without departing from the scope of the present technology and various implementations as disclosed.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present implementation(s). Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. For example, the technology includes a module for detecting background noise and a module for dynamically adjusting the sensitivity of wake word detection. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example implementation, the machine operates as a standalone device or may be connected (e.g., networked) to other machines. For example the technology as disclosed is intended to be integrated with a hands free voice activated user interface. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers can include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices can also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The various attention processing for voice wake up examples shown above illustrate a method for dynamically adjusting wake word sensitivity algorithms. A user of the present technology as disclosed may choose any of the above attention processing implementations, or an equivalent thereof, depending upon the desired application. In this regard, it is recognized that various forms of the subject wake word sensitivity method could be utilized without departing from the scope of the present invention.

As is evident from the foregoing description, certain aspects of the present technology as disclosed are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

What is claimed is:

1. An attention processing system for dynamically adjusting natural Voice wakeup sensitivity comprising:
a wake-word detection system having a detection sensitivity threshold whereby if said detection sensitivity threshold is exceeded a wake-word detection trigger is activated; and
whereby said detection sensitivity threshold is the sum of a predefined threshold baseline and a dynamically adjustable threshold that is dynamically adjusted based on parameters illustrative of the environment where the wake word detection system is located.

2. The attention processing system as recited in claim 1, where parameters illustrative of the environment are one or more of the physical characteristics of the room, the characteristics of the sound sources and audible sound, and the characteristics of the user's interaction with the wake word detection system.

3. The attention processing system as recited in claim 1, where parameters illustrative of the environment are two or more parameters including parameters relating to one or more of the physical characteristics of the room, the characteristics of the sound sources and audible sound, and the characteristics of the user's interaction with the wake word detection system.

4. The attention processing system as recited in claim 3, where the two or more parameters include one or more of Time Since The Last Wake-word Was Detected and Level Of Noise in the environment.

5. The attention processing system as recited in claim 4, where the two or more parameters are logically AND'd to determine the dynamically adjusted threshold.

6. An attention processing method for dynamically adjusting natural Voice Wakeup Sensitivity comprising:
providing a wake-word detection system that is activating a wake-word detection trigger when a detection sensitivity threshold is exceeded, whereby said detection sensitivity threshold is the sum of a predefined threshold baseline and a dynamically adjustable threshold that is dynamically adjusted based on parameters illustrative of the environment where the wake word detection system is located; and
triggering the wake word detection trigger, when the detection sensitivity threshold is exceeded.

7. The attention processing method as recited in claim 6, where parameters illustrative of the environment are one or more of the physical characteristics of the room, the characteristics of the sound sources and audible sound, and the characteristics of the user's interaction with the wake word detection system.

8. The attention processing method as recited in claim 6, where parameters illustrative of the environment are two or more parameters including parameters relating to one or more of the physical characteristics of the room, the characteristics of the sound sources and audible sound, and the characteristics of the user's interaction with the wake word detection system.

9. The attention processing method as recited in claim 8, where the two or more parameters include one or more of Time Since The Last Wake-word Was Detected and Level Of Noise in the environment.

10. The attention processing method as recited in claim 9, where the two or more parameters are logically AND'd to determine the dynamically adjusted threshold.
